(19) United States
(12) Patent Application Publication
(10) Pub. No.: US 2025/0372324 A1
(43) Pub. Date: Dec. 4, 2025

(54) MEDIUM VOLTAGE SWITCHING APPARATUS

(71) Applicant: ABB Schweiz AG, Baden (CH)

(72) Inventors: Roberto Piazza, Codogno (LO) (IT); Gianluca Cortinovis, Albino (BG) (IT); Jacopo Bruni, Lodi (IT)

(21) Appl. No.: 19/222,068

(22) Filed: May 29, 2025

(30) Foreign Application Priority Data
Jun. 3, 2024 (EP) 24179604.4

(51) Int. Cl. H01H 33/666; H01H 31/00; H01H 33/12; H01H 33/664

(52) U.S. Cl. CPC H01H 33/6661; H01H 31/003; H01H 33/126; H01H 33/664; H01H 33/6664

(57) ABSTRACT

The present disclosure relates to a switching apparatus comprising one or more electrical poles, wherein for each electric pole, the switching apparatus comprises a first fixed contact electrically connected to a first pole terminal, a second fixed contact electrically connected to a second pole terminal and a third fixed contact electrically connected to a ground terminal. The switching apparatus further comprises a movable contact, which is reversibly movable about a corresponding rotation axis so that said movable contact can be coupled to or uncoupled from one or more of the above-mentioned fixed contacts, and a vacuum interrupter. An auxiliary contact is electrically connected to said fixed arc contact and a contact lever is electrically connected to said auxiliary contact and reversibly movable about a corresponding second rotation axis. The contact lever is couplable to said movable contact to electrically connect said movable contact to said auxiliary contact.

### CROSS REFERENCE TO RELATED APPLICATIONS

The present application claims priority to European Patent Application No. 24179604.4 filed on Jun. 3, 2024, and titled “A MEDIUM VOLTAGE SWITCHING APPARATUS”, which is hereby incorporated by reference in its entirety.

### TECHNICAL FIELD

The present disclosure relates to a switching apparatus for medium voltage electric systems, more particularly to a load-break switch for medium voltage electric systems.

### BACKGROUND

Load-break switches are well known in the state of the art.

These switching apparatuses, which are generally used in secondary distribution electric grids, can provide circuit-breaking functionalities (namely breaking and making a current) under specified circuit conditions (typically nominal or overload conditions) as well as providing circuit-disconnecting functionalities (namely grounding a load-side section of an electric circuit).

Most traditional load-break switches of the state of the art have their electric poles immersed in a sulphur hexafluoride (SF₆) atmosphere as this insulating gas ensures excellent performances in terms of dielectric insulation between live parts and arc-quenching capabilities when currents are interrupted.

As is known, however, SF₆ is a powerful greenhouse gas, and its usage is subject to severe restriction measurements for environmental preservation purposes. For this reason, over the years, there has been made a considerable effort to develop and design load-break switches not employing SF₆ as an insulating gas.

Some load-break switches have been developed, in which electric poles are immersed in pressurized dry air or other environment-friendly insulation gases, such as mixtures of oxygen, nitrogen, carbon dioxide and/or fluorinated gases. Unfortunately, the experience has shown that these switching apparatuses generally do not show fully satisfactory performances, particularly in terms of arc-quenching capabilities.

Other currently available load-break switches employ, for each electric pole, different contact arrangements electrically connected in parallel between the pole terminals.

A contact arrangement has electric contacts operating in an atmosphere filled with an environment-friendly insulating gas or air and it is designed for carrying most of the current flowing along the electric pole as well as driving possible switching maneuvers.

Another contact arrangement, instead, has electric contacts operating in a vacuum atmosphere and it is specifically designed for quenching the electric arcs arising when the current flowing along the electric pole is interrupted.

These last switching apparatuses have proven to ensure a relatively low environmental impact while providing, at the same time, high-level performances in terms of dielectric insulation and arc-quenching capabilities. However, until now, switches have adopted complicated solutions to manage and coordinate the operation of the above-mentioned multiple contact arrangements. Therefore, the switches still offer poor performances in terms of structural compactness and reliability in operation.

### BRIEF DESCRIPTION

The main aim of the present disclosure is to provide a switching apparatus for MV electric systems that allows solving or mitigating the above-mentioned technical problems.

More particularly, it is an object of the present disclosure to provide a switching apparatus ensuring high-level performances in terms of dielectric insulation and arc-quenching capabilities during the current breaking process.

Another object of the present disclosure is to provide a switching apparatus showing high levels of reliability in operation.

Another object of the present disclosure is to provide a switching apparatus having electric poles with high compactness and structural simplicity.

Another object of the present disclosure is to provide a switching apparatus that can be easily manufactured at industrial level, at competitive costs with respect to the solutions of the state of the art.

To fulfill these aim and objects, the present disclosure provides a switching apparatus, according to the claims.

In a general definition, the switching apparatus of the present disclosure comprises one or more electric poles.

For each electric pole, the switching apparatus comprises a first pole terminal, a second pole terminal and a ground terminal. In operation, the first pole terminal can be electrically coupled to a first conductor of an electric line, the second pole terminal can be electrically coupled to a second conductor of said electric line and the ground terminal can be electrically coupled to a grounding conductor.

For each electric pole, the switching apparatus comprises a plurality of fixed contacts spaced apart one from another. Such a plurality of fixed contacts comprises a first fixed contact electrically connected to the first pole terminal, a second fixed contact electrically connected to the second pole terminal and a third fixed contact electrically connected to the ground terminal.

For each electric pole, the switching apparatus further comprises a movable contact, which is reversibly movable about a corresponding rotation axis according to opposite first and second rotation directions, so that said movable contact can be mechanically and electrically coupled to or uncoupled from one or more of the above-mentioned fixed contacts.

For each electric pole, the switching apparatus further comprises a vacuum interrupter, which comprises a fixed arc contact and a movable arc contact reversibly movable along a corresponding translation axis between a coupled position with the fixed arc contact and an uncoupled position from the fixed arc contact. The vacuum interrupter additionally comprises a vacuum chamber, in which the fixed arc contact and the movable arc contact are enclosed and can be coupled or decoupled.

For each electric pole, the switching apparatus further comprises a motion transmission mechanism mechanically coupled to the movable arc contact. Such a motion transmission mechanism is actuatable by said movable contact, when said movable contact moves about said rotation axis, to cause a movement of said movable arc contact along said translation axis.

For each electric pole, the switching apparatus further comprises an auxiliary contact arrangement including an auxiliary contact electrically connected to said fixed arc contact and a contact lever electrically connected to said auxiliary contact and reversibly movable about a corresponding second rotation axis.

Said contact lever is couplable to said movable contact to connect electrically said movable contact to said auxiliary contact in a transient manner, during an opening maneuver and a closing maneuver of said switching apparatus.

In some embodiments, said movable contact couples to said contact lever before decoupling from said first fixed contact, during an opening maneuver of said switching apparatus.

In some embodiments, said movable contact couples to said first fixed contact before decoupling from said contact lever, during a closing maneuver of said switching apparatus.

In some embodiments, said contact lever moves from a rest position to a first transient position, upon actuation by said movable contact, when said movable contact couples to said contact lever, during an opening maneuver of said switching apparatus.

In some embodiments, said contact lever moves back from said first transient position to said rest position, upon actuation by a first elastic member of said auxiliary contact arrangement, when said movable contact decouples from said contact lever, during an opening maneuver of said switching apparatus.

In some embodiments, said contact lever moves from a rest position to a second transient position, upon actuation by said movable contact, when said movable contact couples to said contact lever, during a closing maneuver of said switching apparatus.

In some embodiments, said contact lever moves back from said second transient position to said rest position, upon actuation by a second elastic member of said auxiliary contact arrangement, when said movable contact decouples from said contact lever, during a closing maneuver of said switching apparatus.

According to an aspect of the present disclosure, said auxiliary contact arrangement comprises a support member pivoted on a fixed support and supporting said auxiliary contact and said contact lever, which is pivoted on said support member.

According to an aspect of the present disclosure, said auxiliary contact arrangement further comprises a first elastic member arranged between a fixed support and said support member or said auxiliary contact.

According to an aspect of the present disclosure, said auxiliary contact arrangement further comprises a second elastic member arranged between said support member or said auxiliary contact and said contact lever.

According to an aspect of the present disclosure, the motion transmission mechanism comprises at least a first lever member pivoted on a fixed support at a first hinge axis and at least a second lever member pivoted on said movable arc contact at a second hinge axis.

Each first lever member and each corresponding second lever member are pivoted one on another at a third hinge axis.

In some embodiments, said motion transmission mechanism is configured to take alternatively a first configuration, at said movable arc contact is in said coupled position, and a second configuration, at which said movable arc contact is in said uncoupled position.

In some embodiments, said motion transmission mechanism is configured to maintain stably said first configuration or said second configuration if the lever arms of each first lever member are not actuated by said movable contact.

In some embodiments, said motion transmission mechanism is configured to change configuration if a lever arm of each first lever member is actuated by said movable contact.

More particularly, said motion transmission mechanism is configured to switch from said first configuration to said second configuration upon an actuation of the first lever arm of each first lever member by said movable contact and is configured to switch from said second configuration to said first configuration upon an actuation of the second lever arm of each first lever member by said movable contact.

A transition of said motion transmission mechanism from said first configuration to said second configuration causes a movement of said movable arc contact from said coupled position to said uncoupled position while a transition of said motion transmission mechanism from said second configuration to said first configuration causes a movement of said movable arc contact from said uncoupled position to said coupled position.

### BRIEF DESCRIPTION OF DRAWINGS

Further characteristics and advantages of the present disclosure will emerge from the description of exemplary embodiments of the switching apparatus, according to the present disclosure, non-limiting examples of which are provided in the attached drawings.

FIG. 1 shows an outer view of the switching apparatus of the present disclosure.

FIG. 2 schematically shows the electric poles of the switching apparatus of the present disclosure.

FIGS. 3-16 are schematic views partially showing the structure and operation of an electric pole of the switching apparatus of the present disclosure.

FIGS. 17-19 are schematic views showing some structural and operation details of an electric pole of the switching apparatus, according to the present disclosure.

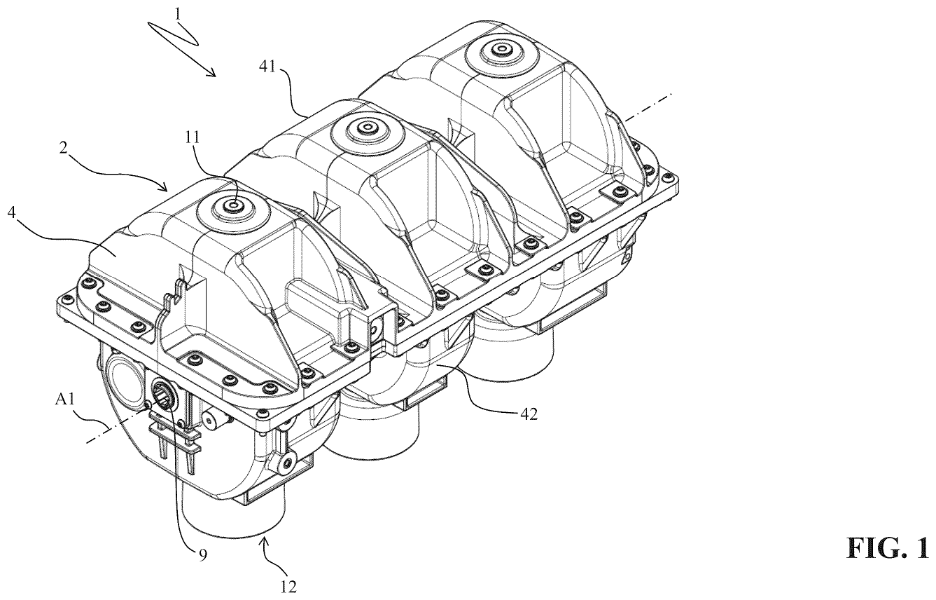

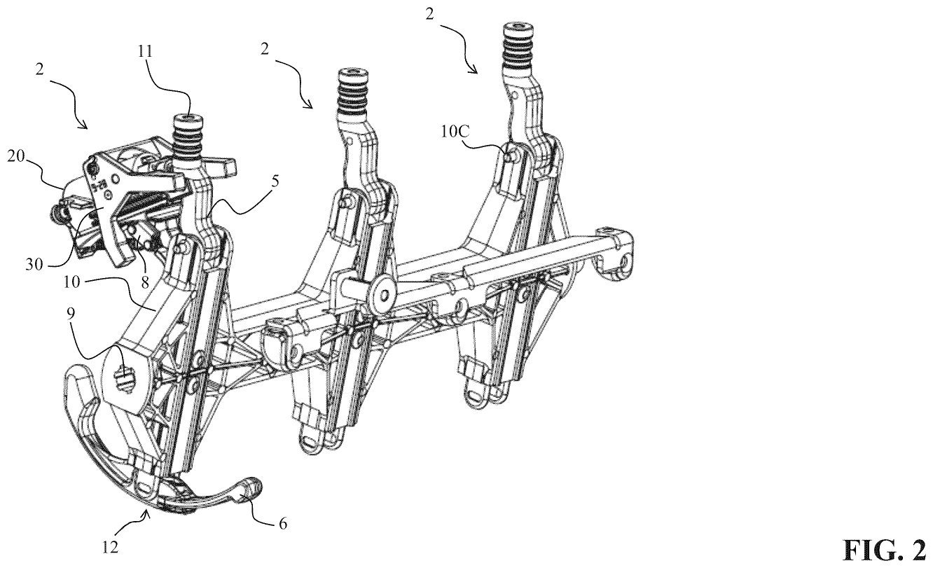

### DETAILED DESCRIPTION

With reference to the above-mentioned figures, the present disclosure relates to a switching apparatus 1 for medium voltage electric systems.

For the purposes of the present disclosure, the term “medium voltage” (MV) relates to operating voltages at electric power distribution level, which are higher than 1 kV AC and 1.5 kV DC up to some tens of kV, e.g., up to 72 kV AC and 100 kV DC.

The switching apparatus 1 is particularly adapted to operate as a load-break switch. It is therefore designed for providing circuit-breaking functionalities under specified circuit conditions (nominal or overload conditions) as well as circuit-disconnecting functionalities, in particular grounding a load-side section of an electric circuit.

In the following, the switching apparatus of the present disclosure will be described with particular reference to this application for the sake of simplicity only and without intending to limit the scope of the present disclosure.

The switching apparatus 1 comprises one or more electric poles 2.

In some embodiments, the switching apparatus 1 is of the multi-phase (e.g., three-phase) type and it comprises a plurality (e.g., three) of electric poles 2.

According to the embodiments shown in the cited figures, the switching apparatus 1 comprises an insulating housing 4 conveniently defining an internal volume where the electric poles 2 are accommodated.

In some embodiments, the insulating housing 4 has an elongated shape (e.g. substantially cylindrical) developing along a main longitudinal axis. The electric poles 2 are arranged side by side along corresponding transversal planes perpendicular the main longitudinal axis of the switching apparatus.

In some embodiments, the insulating housing 4 is formed by an upper shell 41 and a lower shell 42 that are mutually joined along suitable coupling edges.

In the following, the switching apparatus of the present disclosure will be described with reference to these embodiments for the sake of brevity only and without intending to limit the scope of the present disclosure. Indeed, according to other embodiments of the present disclosure (not shown), the switching apparatus of the present disclosure might be installed in a cubicle together with other electric devices. In this case, the switching apparatus may not comprise a housing as shown in the cited figures.

In some embodiments, the internal components of the switching apparatus 1 are immersed in an atmosphere of pressurized dry air or another insulating gas having a low environmental impact, such as a mixture of oxygen, nitrogen, carbon dioxide and/or a fluorinated gas.

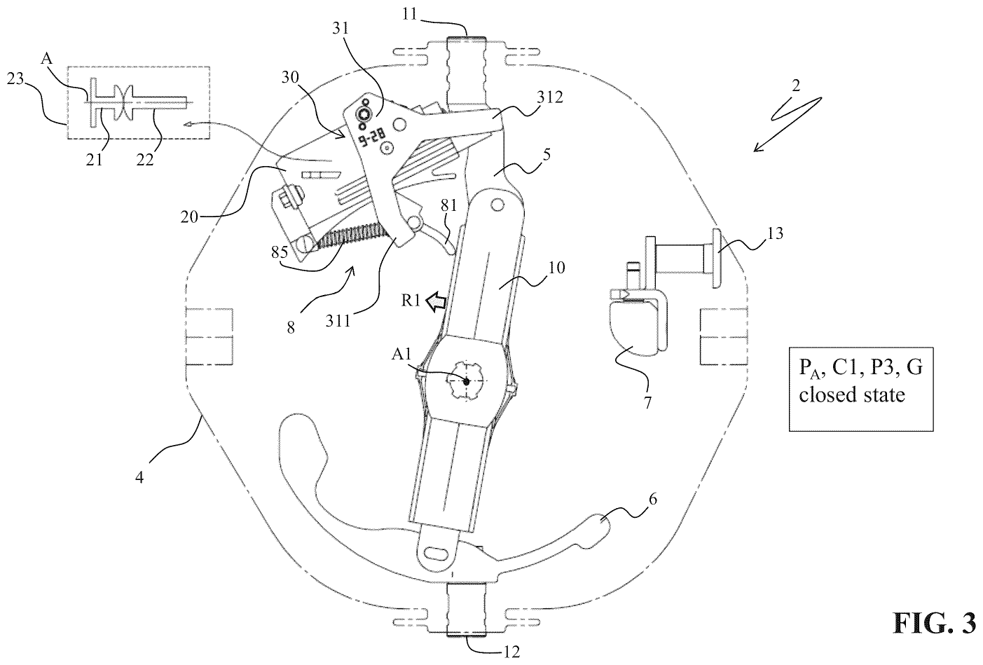

For each electric pole 2, the switching apparatus 1 comprises a first pole terminal 11, a second pole terminal 12 and a ground terminal 13 (FIGS. 3-10).

The first pole terminal 11 is configured to be electrically coupled to a first conductor of an electric line (e.g. a phase conductor electrically connected to an equivalent electric power source), the second pole terminal 12 is configured to be electrically connected to a second conductor of an electric line (e.g. a phase conductor electrically connected to an equivalent electric load), while the ground terminal 13 is configured to be electrically connected to a grounding conductor.

In some embodiments, for each electric pole, the first and second pole terminals 11, 12 are arranged at opposite sides of the switching apparatus.

For each electric pole 2, the switching apparatus 1 comprises a plurality of fixed contacts, which are spaced apart one from another around the main longitudinal axis of the switching apparatus. In particular, the switching apparatus 1 comprises a first fixed contact 5, a second fixed contact 6 and a third fixed contact 7.

The first fixed contact 5 is electrically connected to the first pole terminal 11, the second fixed contact 6 is electrically connected to the second pole terminal 12 and the third fixed contact 7 is electrically connected to the ground terminal 13.

Advantageously, the above-mentioned fixed contacts 5, 6, 7 may be formed by corresponding pieces of conductive material, which are suitably shaped according to the needs.

The switching apparatus 1 comprises, for each electric pole 2, a movable contact 10 reversibly movable (along a given plane of rotation) about a corresponding rotation axis A1, which is substantially parallel to or coinciding with the main longitudinal axis of the switching apparatus.

The movable contact 10 can rotate according to a first rotation direction R1, which is conveniently oriented away from the first fixed contact 5, or according to a second rotation direction R2, which is opposite to the first rotation direction R1 and is oriented towards the first fixed contact 5. With reference to the observation plane of FIGS. 3-10 and 11-16, the above-mentioned first rotation direction R1 is oriented counterclockwise while the above-mentioned second rotation direction R2 is oriented clockwise.

Advantageously, the movable contact 10 is formed by a shaped piece of conductive material, e.g., by an elongated conductive body centered on the rotation axis A1 and oriented perpendicularly to this latter.

The movable contact has one or more free ends, at which it includes one or more corresponding contact regions.

In some embodiments, each contact region of the movable contact 10 includes at least a contact blade, and in some embodiments a pair of contact blades arranged in parallel.

In operation, the switching apparatus 1 can switch in three different operating states. One operating state is a closed state, in which each electric pole 2 has the first and second pole terminals 11, 12 electrically connected one to another and electrically disconnected from the ground terminal 13. When the switching apparatus is in a closed state, a current can flow along each electric pole 2 between the corresponding first and second pole terminals 11, 12. A second operating state is an open state, in which each electric pole 2 has the first and second pole terminals 11, 12 and the ground terminal 13 electrically disconnected one from another. When the switching apparatus is in an open state, no currents can flow along the electric poles 2. A third operating state is a grounded state, in which each electric pole 2 has the first and second pole terminals 11, 12 electrically disconnected one from another and the second pole terminal 12 and the ground terminal 13 electrically connected one to another. When the switching apparatus is in a grounded state, no currents can flow along the electric poles 2. However, the second pole terminal 12 of each electric pole (and therefore the second line conductor connected thereto) is put at a ground voltage.

In principle, the switching apparatus 1 may be of the “single-disconnection” type (not shown) or “double-disconnection” type (as shown in the cited figures) depending on how the current path through each electric pole is interrupted when the switching apparatus reaches an open state.

If the switching apparatus is of the “single disconnection” type, the movable contact 10 is electrically coupled to the second fixed contact 6 and it is electrically coupled to and electrically decoupled from the remaining fixed contacts 5, 7 when the switching apparatus is in an open state. The current path through each electric pole is thus interrupted at a single end of the movable contact 10 (“single disconnection”). The movable contact 10 has thus only a contact region at a suitable free end, which can be coupled to or decoupled from the first and third fixed contacts 5, 7.

If the switching apparatus is of the “double disconnection” type, the movable contact 10 is electrically decoupled from any fixed contact 5, 6, 7 when the switching apparatus is in an open state. The current path through each electric pole is thus interrupted at both opposite free ends of the movable contact (“double disconnection”). The movable contact 10 has thus opposite first and second contact regions. At a first contact region, the movable contact 10 can be coupled to or decoupled from the first and third fixed contacts 5, 7 while, at a second contact region, the movable contact 10 can be coupled to or decoupled from the second fixed contacts 6.

In the following, the switching apparatus of the present disclosure will be described with reference to the above-mentioned “double disconnection” configuration, for the sake of brevity only and without intending to limit the scope of the present disclosure.

The switching apparatus 1 is capable of carrying out different type of maneuvers, each corresponding to a transition among the above-mentioned operating states. In particular, the switching apparatus is capable of carrying out at least the following maneuvers. A first maneuver is an opening maneuver when it switches from a closed state to an open state. A second maneuver is a closing maneuver when it switches from an open state to a closed state. A third maneuver is a closing-to-ground maneuver when it switches from an open state to a grounded state. A fourth maneuver is an opening-from-ground maneuver when it switches from a grounded state to an open state.

The switching apparatus can switch from a closed state to a grounded state by carrying out an opening maneuver and subsequently a closing-to-ground maneuver while the switching apparatus can switch from a grounded state to a closed state by carrying out an opening-from-ground maneuver and subsequently a closing maneuver.

In order to carry out the above-mentioned maneuvers, the movable contact 10 of each electric pole is suitably driven according to the above-mentioned first rotation direction R1 or second rotation direction R2.

In particular, the movable contact 10 moves according to the first rotation direction R1 during an opening maneuver or a closing-to-ground maneuver of the switching apparatus and it moves according to the second rotation direction R2 during a closing maneuver or an opening-from-ground maneuver of the switching apparatus (reference is made to the observation plane of FIGS. 3-9 and 10-15).

In general, the movable contact 10 of each electric pole is reversibly movable between a first end-of-run position P_{A}, which corresponds to a closed state of the switching apparatus, and a second end-of-run position P_{C}, which corresponds to a grounded state of the switching apparatus. Conveniently, the movable contact 10 passes through an intermediate position P_{B}, which corresponds to an open state of the switching apparatus, when it moves between the first and second end-of-run positions P_{A}, P_{C}.

As it is reversibly movable about the rotation axis A1, the movable contact 10 can be mechanically and electrically coupled to or uncoupled from one or more of the fixed contacts 5, 6, 7 thereby electrically connecting or electrically disconnecting these fixed contacts depending on the on-going maneuver.

When it is in the first end-of-run position P_{A} (closed state of the switching apparatus), the movable contact 10 is coupled to the first fixed contact 5 and to the second fixed contact 6 and it electrically connects these latter and the first and second pole terminals 11, 12.

When it is in the second end-of-run position P_{C} (grounded state of the switching apparatus), the movable contact 10 is coupled to the second fixed contact 6 and to the third fixed contact 7 and it electrically connects these latter and the second and third pole terminals 12, 13.

In some embodiments, when it is in the intermediate position P_{B} (open state of the switching apparatus), the movable contact 10 is coupled to no fixed contacts (“double disconnection” configuration).

In some embodiments, the switching apparatus 1 comprises an actuation assembly providing suitable actuation forces to actuate the movable contacts 10 of the electric poles.

In some embodiments, such an actuation assembly comprises a motion transmission shaft 9 made of electrically insulating material, which can rotate about the rotation axis A1, and it is coupled to the movable contacts 10 of the electric poles 2.

The motion transmission shaft 9 thus provides rotational mechanical forces to actuate the movable contacts 10 during the maneuver of the switching apparatus.

In some embodiments, the above-mentioned actuation assembly comprises an actuator (not shown) coupled to the transmission shaft through a suitable kinematic chain (not shown). The actuator may be, for example, a mechanical actuator, an electric motor, or an electromagnetic actuator.

In general, the actuation assembly of the switching apparatus may be realized according to solutions of known type. Therefore, in the following, it will be described only in relation to the aspects of interest of the present disclosure, for the sake of brevity.

According to the present disclosure, for each electric pole 2, the switching apparatus 1 comprises a vacuum interrupter 20.

The vacuum interrupter 20 comprises a fixed arc contact 21 and a movable arc contact 22.

The fixed arc contact 21 can be formed by a corresponding piece of conductive material, which is suitably shaped according to the needs.

The movable arc contact 22 can be formed by an elongated body of conductive material having free end intended to be couple with or decouple from the fixed contact 21.

The movable arc contact 22 is reversibly movable along a corresponding translation axis A, which in some embodiments is aligned with a main longitudinal axis of the vacuum interrupter (and of the conductive body of the movable contact itself).

As it is reversibly movable about the displacement axis A, the movable arc contact 22 can be coupled to or uncoupled from the fixed arc contact 21, thereby being electrically connected to or electrically disconnected from this latter.

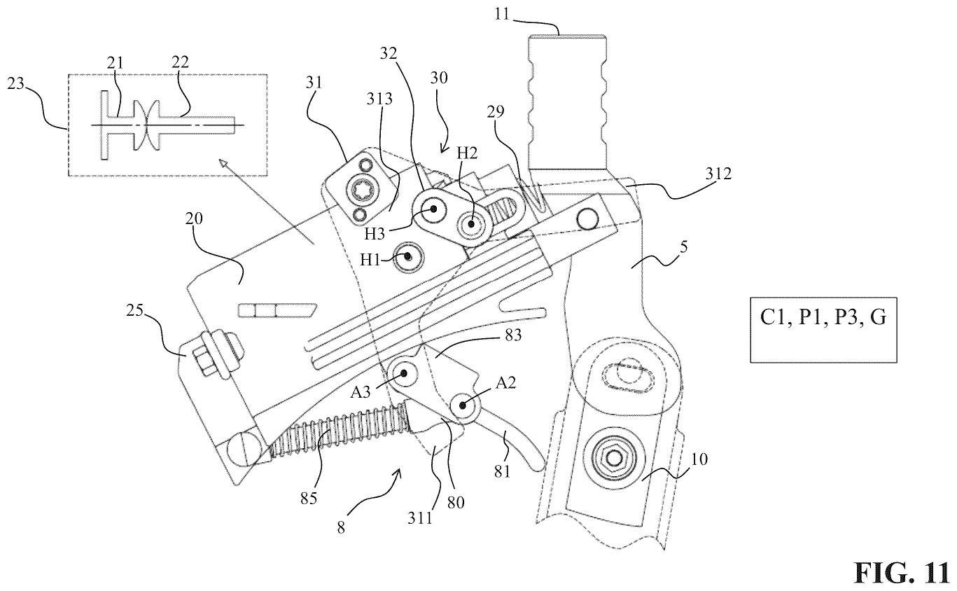

The movable arc contact 22 is electrically connected to first pole terminal 11 through a conductive element 29 (FIGS. 11-17).

In principle, the conductive element 29 may be of any type, for example a flexible conductor or another equivalent arrangement.

In some embodiments, however, the conductive element 29 is a contact spring, for example a coil-shaped compression spring arranged coaxially to the movable arc contact 22 and having opposite ends coupled to the movable arc contact 22 and the first pole terminal 11.

The contact spring 29 opposes to any movement of the movable arc contact 22 away from the fixed arc contact 21 and in some embodiments it is mounted in a preloaded condition in such a way to exert a constant compression force directed to press the movable arc contact 22 towards the fixed arc contact 21.

The vacuum interrupter 20 comprises a vacuum chamber 23, in which a vacuum atmosphere is present. Conveniently, the fixed arc contact 21 and the movable arc contact 22 are partially enclosed in the vacuum chamber 23 in such a way to have corresponding coupling surfaces mutually coupled or decoupled inside the vacuum chamber, therefore being permanently immersed in a vacuum atmosphere.

In some embodiments, the vacuum interrupter 20 comprises a fixed support structure 25 made of electrically insulating material to hold the vacuum chamber 23 in its operating position. Conveniently, the fixed support structure 25 is also used for supporting other components of the switch pole as better explained in the following.

For each electric pole 2, the switching apparatus 1 comprises a motion transmission mechanism 30 operatively coupled to the movable arc contact 22 and actuatable by the movable contact 10 to cause a movement of the movable arc contact 22, when such a movable contact moves about its rotation axis A1.

In some embodiments, the motion transmission mechanism 30 comprises one or more first lever members 31 pivoted on a fixed support (for example the above-mentioned fixed support structure 25) at a fixed first hinge axis H1. The first hinge axis H1 is “fixed” in the sense that it cannot be subject to any translation with respect to the fixed support 25 on which each first lever member 31 is pivoted. Each first lever member 31 can thus only rotate about the first hinge axis H1.

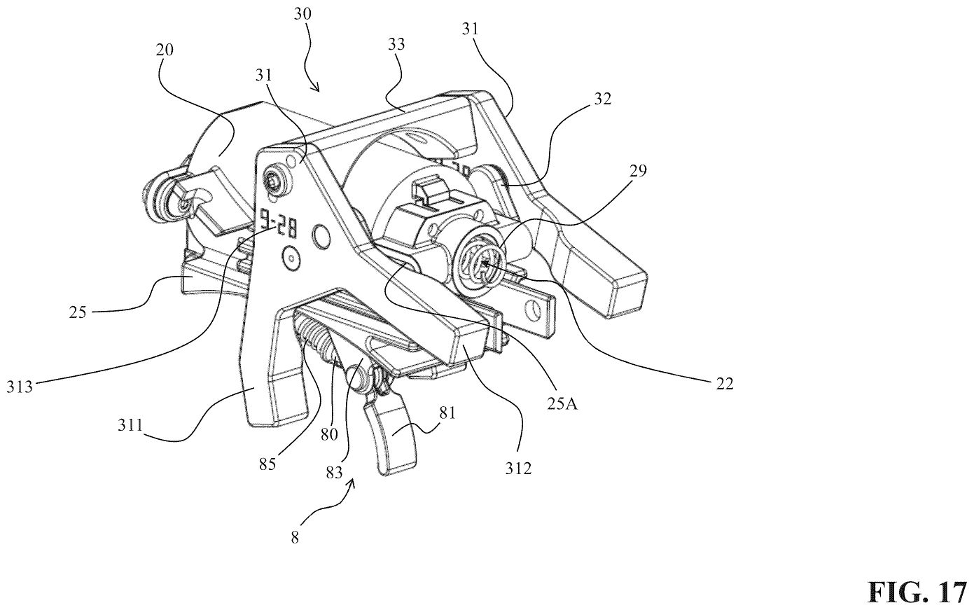

In some embodiments, the motion transmission mechanism 30 comprises one or more second lever members 32 pivoted on the movable arc contact 22 at a fixed second hinge axis H2. As for the first hinge axis H1, the second hinge axis H2 cannot be subject to any translation with respect to the movable contact 22, on which the second lever members 32 are pivoted. Each second lever member 32 can thus rotate only about the second hinge axis H2. Obviously, the second hinge axis H2 moves together with the movable arc contact 22. To this aim, the fixed support structure 25 of the vacuum chamber may include a suitable slot 25A (FIG. 17).

It is noted that each pair of corresponding first and second lever members 31, 32 rotate according to opposite directions about the respective hinge axes H1, H2 when the motion transmission mechanism 30 is actuated by the movable contact 10.

According to the present disclosure, each first lever member 31 is pivoted on a corresponding second lever member 32 at a movable third hinge axis H3. The third hinge axis H3 is “movable” in the sense that it can be subject to opposite translation movements along a reference plane perpendicular to the rotation axis A1 of the movable contact 10. Any given first lever member 31 and the corresponding second lever member 32 can therefore rotate (conveniently according to opposite relative rotation directions) about the hinge axis H3.

Conveniently, the above-mentioned hinge axes H1, H2, H3 of the first and second lever members 31, 32 are parallel to the rotation axis A1 of the movable contact 10.

In some embodiments, each first lever member 31 comprises a connecting portion 313, at which said first lever member is pivoted on the fixed support 25 at the first hinge axis H1 and is pivoted on a corresponding second lever member 32 at the third hinge axis H3 (FIGS. 11-18).

According to the present disclosure, each first lever member 31 further comprises first and second lever arms 311, 312 spaced apart one from another and extending from the hinge axis H1 (more particularly from the connecting portion 313) towards the movable contact 10. The first and second lever arms 311, 312 are configured so that they are alternatively actuatable by the movable contact 10 at different points of the motion trajectory of the movable contact.

In some embodiments, the first and second lever arms 311, 312 extend along different directions in such a way to be angularly spaced one from another. In this way, the first and second lever arms 311, 312 can alternatively intersect the motion trajectory of the movable contact 10 depending on the configuration taken by the motion transmission mechanism 30.

In some embodiments, each first lever member 31 has the first and second lever arms 311, 312 configured so that the first lever arm 311 of each first lever member 31 is actuated by the movable contact 10, when said movable contact moves according to the first rotation direction R1, and so that the second lever arm 312 of each first lever member 31 is actuated by the movable contact 10, when said movable contact moves according to the second rotation direction R2.

In some embodiments, each first lever member 31 has first and second lever arms 311, 312 configured so that the first lever arm 311 of each first lever member 31 is actuated by the movable contact 10, during an opening maneuver of the switching apparatus, and so that the second lever arm 312 of each first lever member 31 is actuated by the movable contact 10, during a closing maneuver of the switching apparatus.

As shown in the cited figures, in some embodiments each first lever member 31 is formed by a body of electrically insulating material with a reversed-V shaped configuration, in which the connecting portion 313 joins the lever arms 311, 312 that protrude towards the movable contact 10. Each lever arm 311, 312 has a suitable profile designed to synchronize the actuation of said lever arm and of the movable arc contact 22 by the movable contact 10 with the movements of the movable contact 10 itself.

In some embodiments, each second lever member 32 is formed by a body of electrically insulating material having a blade configuration with opposite ends hinged to the movable arc contact 22 at the second axis H2 and to a corresponding first lever member 31 at the third axis H3, respectively (FIGS. 11-17).

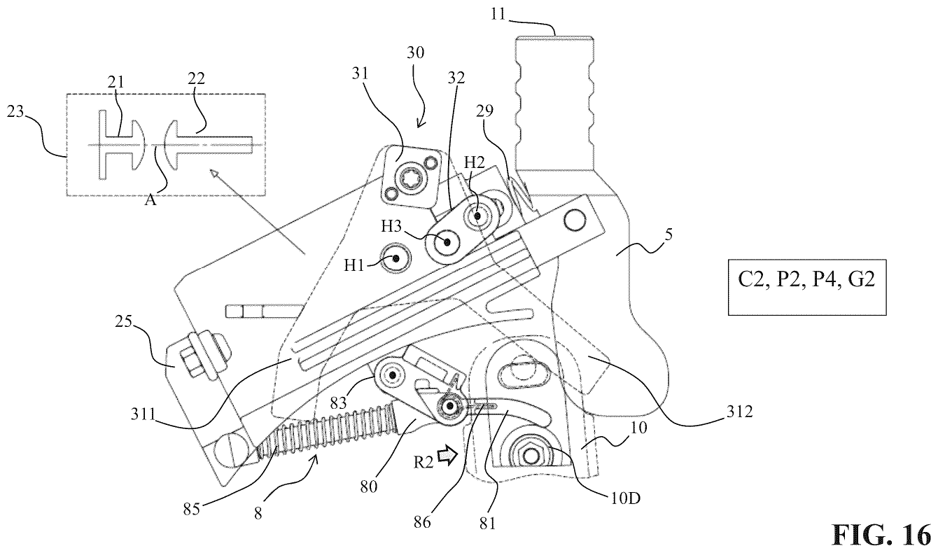

According to some embodiments of the present disclosure (FIGS. 16-17), the motion transmission mechanism 30 comprises a pair of first lever members 31 and a pair of second lever members 32 arranged in parallel one to another at opposite sides of the vacuum chamber 23.

The motion transmission mechanism 30 advantageously comprises at least a reinforcement member 33 joining the first lever members 31 (FIGS. 16-17). In some embodiments, the reinforcement member 33 joins the connecting portions 313 of the opposite-sided first lever members 31.

Additionally, the movable contact 10 has a first contact region including a pair of contact blades arranged in parallel and spaced apart one from another. In this case, each contact blade is configured to actuate the first and second lever arms 311, 312 of a corresponding first lever member 31.

In some embodiments, the movable contact 10 comprises, at its first contact region, one or more first coupling members 10C configured to couple mechanically with the first and second lever arms 311, 312 of one or more corresponding first lever members 31 in such a way to actuate these latter. In some embodiments, coupling member 10C is formed by a coupling pin protruding perpendicularly from a corresponding contact blade of the movable contact.

In general terms, the motion transmission mechanism 30 is configured to take alternatively a first configuration C1 and a second configuration C2.

The first configuration C1 of the motion transmission mechanism 30 corresponds to a closed condition of the vacuum interrupter 20, in the sense that, when the motion transmission mechanism takes this configuration, the movable arc contact 22 is in a coupled position P3 with the fixed arc contact 21.

The second configuration C2 of the motion transmission mechanism 30 corresponds to an open condition of the vacuum interrupter 20, in the sense that, when the motion transmission mechanism takes this configuration, the movable arc contact 22 is in an uncoupled position P4 from the fixed arc contact 21.

In some embodiments, the motion transmission mechanism 30 is configured to maintain stably the first configuration C1 or the second configuration C2, if the lever arms 311, 312 of each first lever member 31 are not actuated by the movable contact 10. Instead, the motion transmission mechanism 10 is configured to switch its configuration, upon actuation of the lever arms 311, 312 of each first lever member 31 by the movable contact 10.

Any transition between the first and second configurations C1, C2 of the motion transmission mechanism 30 causes a corresponding movement of the movable arc contact 22 and a consequent change of condition of the vacuum interrupter 20.

In some embodiments, the motion transmission mechanism 30 is configured to switch from the first configuration C1 to the second configuration C2 upon an actuation of the first lever arm 311 of each first lever member 31 by the movable contact 10 at a first point of the motion trajectory of this latter, during an opening maneuver of the switching apparatus.

The transition of the motion transmission mechanism 30 from the first configuration C1 to the second configuration C2 causes a corresponding movement of the movable arc contact 22 from the coupled position P3 to the uncoupled position P4.

In some embodiments, the motion transmission mechanism 30 is configured to switch from the second configuration C2 to the first configuration C1 upon an actuation by the movable contact 10 at a second point of the motion trajectory of this latter, during a closing maneuver of the switching apparatus.

The transition of the motion transmission mechanism 30 from the second configuration C2 to the first configuration C1 causes a corresponding movement of the movable arc contact 22 from the uncoupled position P4 to the coupled position P3.

The mechanical behavior of the motion transmission mechanism 30 and its mechanical interaction with the movable arc contact 22 is briefly described in the following with reference to FIGS. 11-16.

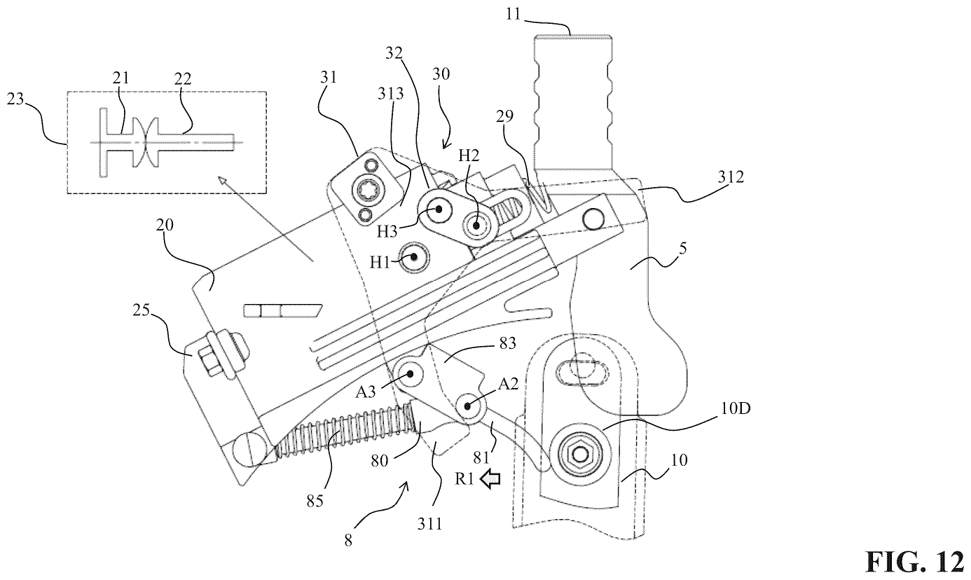

FIGS. 11-12 show the motion transmission mechanism 30 in the first configuration C1.

In this case, the third hinge axis H3 of the lever members 31, 32 is in the first position P1, at which the movable arc contact 22 is in the coupled position P3 with the fixed arc contact 21.

The third hinge axis H3 is not aligned with the fixed hinge axes H1, H2 and the lever members 31, 32 are positioned one to another in such a way that the motion transmission mechanism 30 does not exert any force on the movable arc contact 22.

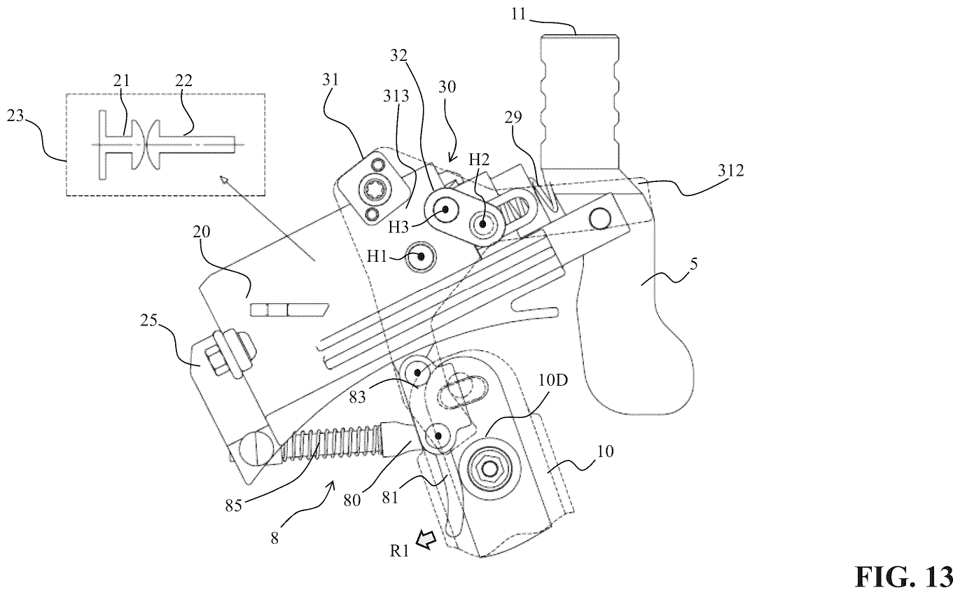

Upon actuation of the first lever arm 311 by the first movable contact 10, during an opening maneuver of the switching apparatus (the movable contact 10 is rotating according to the first rotation direction R1), the first and second lever members 31, 32 rotate according to opposite directions about the respective hinge axes H1, H2. The third hinge axis H3 moves away from the first position P1 and it travels towards a second position P2 (FIG. 13).

The motion transmission mechanism 30 exerts a force on the movable contact arc 22, which is directed to decouple this latter from the fixed arc contact 21.

The movable arc contact 22 moves away from the fixed arc contact 21 notwithstanding the vacuum attraction force generated by the vacuum atmosphere in the vacuum chamber and the compression force exerted by the compression spring 29 coupled to the movable arc contact.

While it is travelling towards the second position P2, the third hinge axis H3 of the lever members 31, 32 passes through an intermediate deadlock position, which can be defined as the position, in which the third hinge axis H3 is aligned with the fixed hinge axes H1 and H2.

As soon as the third hinge axis H3 between the lever members 31, 32 passes beyond said intermediate deadlock position, the movable contact 10 decouples from the first lever arm 311 and stops actuating the first lever member 31.

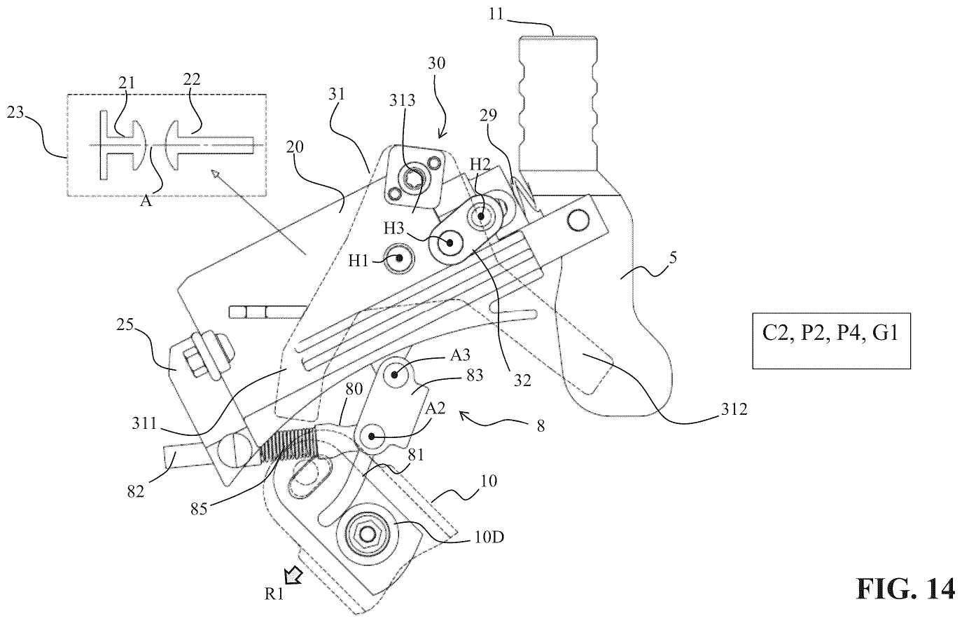

The third hinge axis H3 of the lever members 31, 32 reaches the second position P2 (FIG. 14) and the movable arc contact 22 reaches the uncoupled position P4 from the fixed arc contact 21, which is stably maintained due to the force exerted on the movable arc contact 22 by the motion transmission mechanism 30, which opposes to the vacuum attraction force generated by the vacuum atmosphere in the vacuum chamber and to the compression force exerted by the compression spring 29 coupled to the movable arc contact 22.

FIGS. 14-16 show the motion transmission mechanism 30 in the second configuration C2.

In this case, the third hinge axis H3 of the lever members 31, 32 is in the second position P2, at which the movable arc contact 22 is in the uncoupled position P4 from the fixed arc contact 21.

The third hinge axis H3 is not aligned with the fixed hinge axes H1, H2 and the lever members 31, 32 are relatively positioned one to another, so that the motion transmission mechanism 30 exerts a force on the movable arc contact 22, which is directed to maintain this latter uncoupled from the fixed arc contact 21.

Upon actuation of the second lever arm 312 by movable contact 10, during a closing maneuver of the switching apparatus (the movable contact 10 is rotating according to the second rotation direction R2), the first and second lever members 31, 32 rotate according to opposite directions about the respective hinge axes H1, H2. The third hinge axis H3 moves away from the second position P2 and it travels towards the first position P1.

The motion transmission mechanism 30 initially exerts a force on the movable arc contact 22, which is still directed to decouple this latter from the fixed arc contact 21.

Thus, the movable arc contact 22 furthermore moves away from the fixed arc contact 21 notwithstanding the vacuum attraction force generated by the vacuum atmosphere in the vacuum chamber and the compression force exerted by the compression spring 29.

The movable arc contact 22 reaches the maximum distance from the fixed arc contact 21, when the third hinge axis H3 of the lever members 31, 32 reaches the intermediate deadlock position, while moving away from the second position P2.

As soon as the third hinge axis H3 of the lever members 31, 32 passes beyond the intermediate deadlock position, the movable contact 10 decouples from the second lever arm 312 and stops actuating the first lever member 31.

The motion transmission mechanism 30 stops exerting a force on the movable arc contact 22. The movable arc contact 22 thus starts moving towards the fixed arc contact 21 due to the vacuum attraction force and the compression force exerted by the compression spring 29.

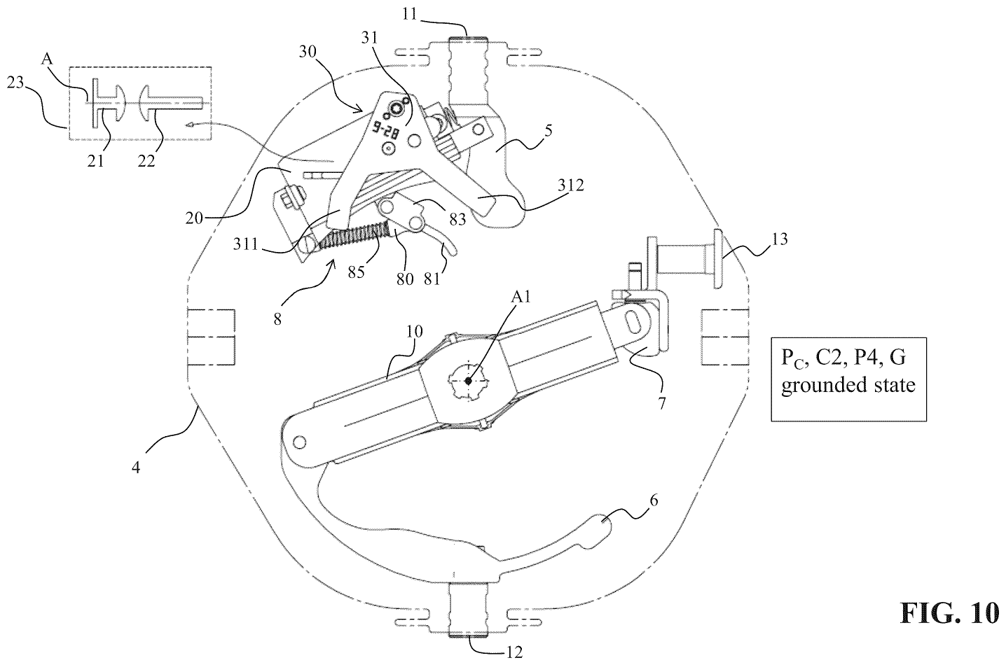

The third hinge axis H3 of the lever members 31, 32 finally reaches the first position P1 (FIG. 10) and the movable arc contact 22 reaches the coupled position P3 with the fixed arc contact 21, which is stably maintained as the motion transmission mechanism 30 does not exert any force on the movable arc contact 22.

According to the present disclosure, the switching apparatus comprises, for each electric pole, an auxiliary contact arrangement 8 to allow the formation of a current path passing through the vacuum interrupter 20 during an opening maneuver and a closing maneuver of the switching apparatus.

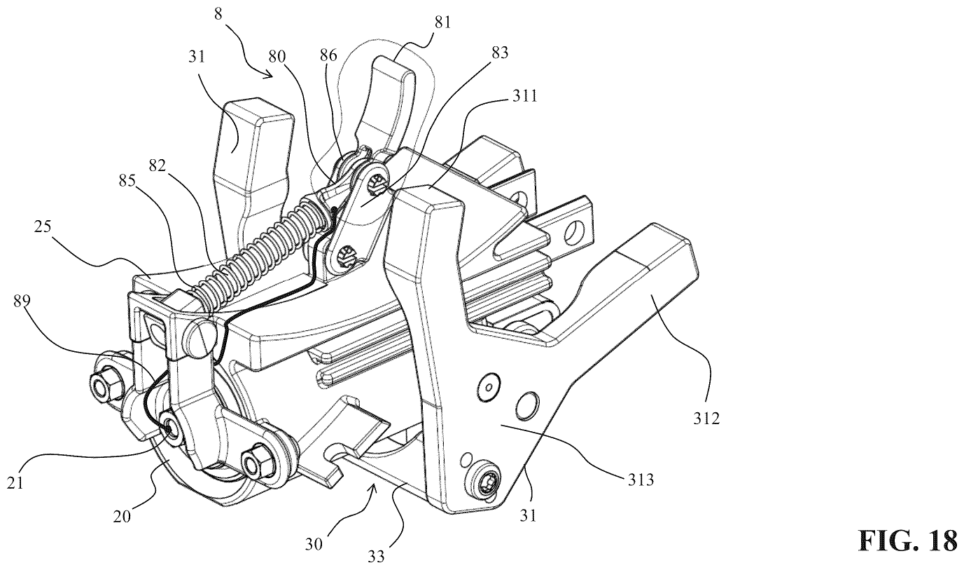

The auxiliary contact arrangement 80 comprises an auxiliary contact 80 electrically connected to the fixed arc contact 21, for example through a suitable connection wire 89 (FIG. 18).

The auxiliary contact arrangement 80 comprises a contact lever 81 electrically connected to the auxiliary contact 80 and reversibly movable about a corresponding second rotation axis A2, which in some embodiments is parallel to the first rotation axis Al of the movable contact 10.

The contact lever 81 is positioned in such a way to intersect the motion trajectory of the movable contact 10 when this latter rotates about its rotation axis A1 during an opening maneuver and a closing maneuver of the switching apparatus.

The contact lever 81 is thus couplable to the movable contact 10 and electrically connect this to the auxiliary contact 80 (and consequently to the fixed arc contact 21) in a transient manner, when the movable contact 10 rotates about its rotation axis A1 during an opening maneuver and a closing maneuver of the switching apparatus.

In some embodiments, the first fixed contact 5 and the contact lever 81 are relatively positioned along the motion trajectory of the movable contact 10 for a number of reasons. The first reason is so that the movable contact 10 couples to the contact lever 81 before decoupling from the first fixed contact 5, when said movable contact moves according to the first rotation direction R1, during an opening maneuver of the switching apparatus. The second reason is that the movable contact 10 couples to the first fixed contact 5 before decoupling from the coupling lever 81, when said movable contact moves according to said second rotation direction R2, during a closing maneuver of the switching apparatus.

When movable contact member 10 is decoupled from the contact lever 81, this latter remains in a rest position G, at which said contact lever intersects the motion trajectory of the movable contact 10.

When it couples to the contact lever 81 during an opening maneuver and a closing maneuver of the switching apparatus, the movable contact 10 actuates the contact lever 81.

The contact lever 81 moves from a rest position G to a first transient position G1, upon actuation by the movable contact 10, when said movable contact couples to the contact lever 81, during an opening maneuver of the switching apparatus.

The contact lever 81 moves from the rest position G to a second transient position G2, upon actuation by the movable contact 10, when said movable contact couples to the contact lever 81, during a closing maneuver of the switching apparatus.

When the movable contact 10 decouples from the contact lever 81 during an opening maneuver or a closing maneuver of the switching apparatus, the contact lever 81 returns to its rest position G upon actuation by suitable first and second elastic members 85, 86 of the movable contact arrangement 8 (which will be better described in the following).

Upon actuation by a first elastic member 85 of the movable contact arrangement 8, the contact lever 81 moves back from the first transient position G1 to the rest position G, when the movable contact decouples from the contact lever 81, during an opening maneuver of the switching apparatus.

Upon actuation by a second elastic member 86 of the movable contact arrangement 8, the contact lever 81 moves back from the second transient position G2 to the rest position G, when the movable contact decouples from the contact lever 81, during a closing maneuver of the switching apparatus.

In some embodiments, the auxiliary contact arrangement comprises a support member 83 to support the auxiliary contact 80 and the contact lever 81. The support member 83 is pivoted on a fixed support, for example the fixed support structure 25, and it is reversibly movable about a corresponding third rotation axis A3, which in some embodiments is parallel to the first rotation axis A1 of the movable contact 10 and the second rotation axis A2 of the contact lever 81. The contact lever 81 is in turn pivoted on the support member 83 and can move about its rotation axis A2.

In the embodiment shown in the cited figures, the auxiliary contact 80 includes a shaped body of conductive material while the contact lever 81 is formed by a curved conductive blade having its convexity oriented towards the fixed contact 5. Advantageously, the support member 83 can be made of electrically insulating material and in some embodiments it is shaped as an open box in such a way to enclose partially the auxiliary contact 80. The contact lever 81 is hinged to the support member 83 and to the auxiliary contact 80 through a suitable connection pin 84 (FIG. 18).

Advantageously, the contact lever 81 and the support member 83 are relatively positioned one to another in such a way that the assembly formed by the support member 83, the auxiliary contact 80 and the contact lever 81 moves as a rigid element pivoted on the fixed support 25, when the movable contact 10 actuates the contact lever 81, during an opening maneuver of the switching apparatus.

In some embodiments, the movable contact 10 comprises, at its first contact region, one or more second coupling members 10D configured to couple mechanically with the coupling lever 81 in such a way to actuate this latter.

In the embodiment shown in the cited figures, the movable contact 10 comprises a single coupling member 10D formed by a coupling pin extending transversally between the opposite contact blades of the movable contact.

As mentioned above, the auxiliary contact arrangement 8 comprises first and second elastic members 81, 82 for actuating the contact lever 81 and moving it back to the rest position G, when the contact lever 81 reaches the first and second transient positions G1, G2 and the movable contact 10 decouples from the contact lever 81, during an opening maneuver and closing maneuver of the switching apparatus.

In some embodiments, the auxiliary contact arrangement 8 comprises a first elastic member 85 arranged between a fixed support, for example the fixed support structure 25, and the assembly formed by the support member 83, the auxiliary contact 80 and the contact lever 81 (FIGS. 11-18).

The first elastic member 85 is arranged in such a way to oppose to a relative movement of the assembly formed by the support member 83, the auxiliary contact 80 and the contact lever 81, when the movable contact 10 actuates the contact lever 81, during an opening maneuver of the switching apparatus.

In principle, the first elastic member 81 may be coupled the support member 83 or the auxiliary contact 80.

In the embodiment shown in the cited figures, the first elastic element 85 is a compression spring arranged between the fixed support 25 and the auxiliary contact 80. The compression spring 85 is arranged coaxially to a support pin 82 (in some embodiments made of electrically insulating material), which has an end coupled to the auxiliary contact 80 and an opposite free end that is slidingly coupled to the fixed support 25 (FIG. 17).

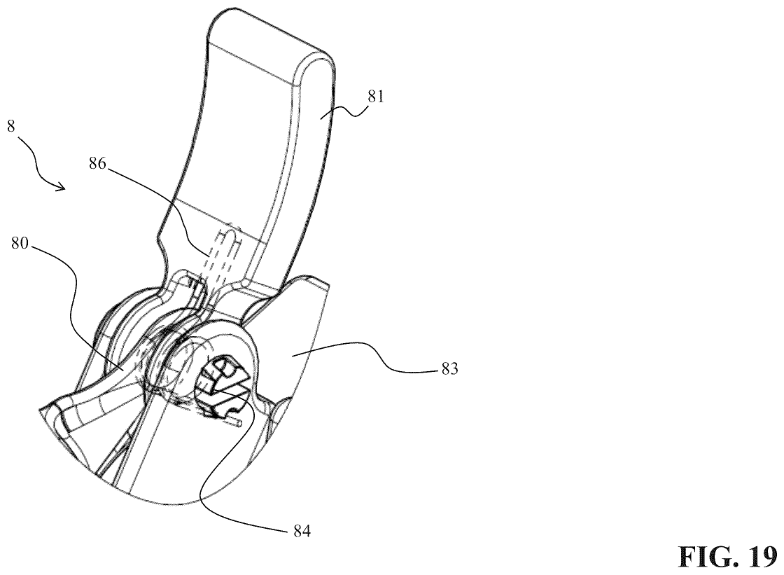

In some embodiments, the auxiliary contact arrangement 8 comprises a second elastic member 86 arranged between the support member 83 or the auxiliary contact 80 and the contact lever 81 (FIG. 19).

The second elastic member 86 is arranged in such a way to oppose to a relative movement of the contact lever 81 relative to the support member 83 and the auxiliary contact 80, when the movable contact 10 actuates the contact lever 81, during an opening maneuver and a closing maneuver of the switching apparatus.

In principle, the second elastic member 82 may be coupled to any of the support member 83 and the auxiliary contact 80.

In the embodiment shown in the cited figures, the second elastic element 86 is a bending spring arranged between the auxiliary contact 80 and the contact lever 81. The bending spring 86 is arranged coaxially to the connection pin 84 coupling the auxiliary contact 80 and the contact lever 81 to the support member 83.

The operation of the switching apparatus 1 (with a “double disconnection” configuration) for each electric pole 2 is now described in more details.

When the switching apparatus is in a closed state, each electric pole 2 is in the operating condition illustrated in FIG. 3.

In this situation, each electric pole 2 has the movable contact 10 in the first end-of-run position P_{A}; the movable contact 10 coupled to the first and second fixed contacts 5, 6; the first and second fixed contacts 5, 6 electrically connected one to another and electrically disconnected from the third fixed contact 7; the coupling lever 81 decoupled from the movable contact 10 and in the rest position G; the auxiliary contact 80 electrically disconnected from the movable contact 10 (and from the second fixed contact 6); the motion transmission mechanism 30 in the first configuration C1; and the movable arc contact 22 in a coupled position P3 with the fixed arc contact 21.

The first lever arm 311 of each first lever member 31 is positioned along the motion trajectory of the movable contact 10 while the second lever arm 312 of each first lever member 31 is not positioned along the motion trajectory of the movable contact 10.

A current can flow through the electric pole between the first and second pole terminals 11, 12 passing through the first fixed contact 5, the movable contact 10 and the second fixed contact 6. No currents can flow through the vacuum interrupter 20 as the auxiliary contact 80 is electrically disconnected from the second fixed contact 6.

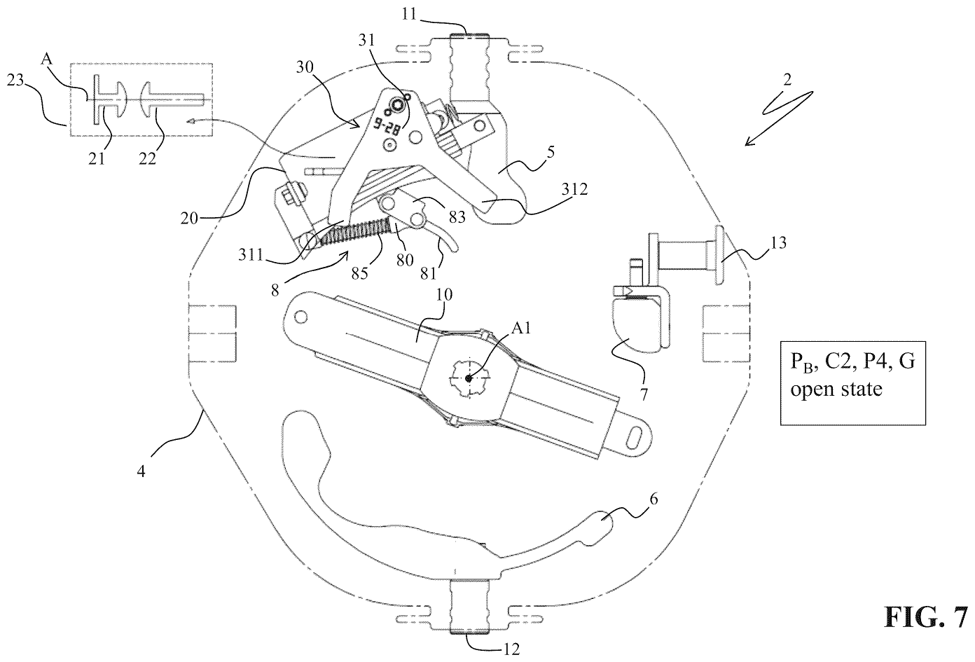

When the switching apparatus is in an open state, each electric pole 2 is in the condition shown in FIG. 7.

In this situation, each electric pole 2 has the movable contact 10 in the intermediate position P_{B}; the movable contact 10 decoupled from any fixed contact; the first, second and third fixed contacts 5, 6, 7 electrically disconnected one from another; the coupling lever 81 decoupled from the movable contact 10 and in the rest position G; the auxiliary contact 80 electrically disconnected from the movable contact 10 (and from the second fixed contact 6); the motion transmission mechanism in the second configuration C2; and the movable arc contact 22 in an uncoupled position P4 from the fixed arc contact 21.

The first lever arm 311 of each first lever member 31 is not positioned along the motion trajectory of the movable contact 10 while the second lever arm 312 of each first lever member 31 is positioned along the motion trajectory of the movable contact 10.

No currents can flow between the first and second pole terminals 11, 12.

When the switching apparatus is in a grounded state, each electric pole 2 is in the condition illustrated in FIG. 10.

In this situation, each electric pole 2 has the movable contact 10 in the second end-of-run position P_{C}; the movable contact 10 coupled to the second and third fixed contacts 6, 7; the second and third fixed contacts 6, 7 electrically connected one to another and electrically disconnected from the first fixed contact 5; the coupling lever 81 decoupled from the movable contact 10 and in the rest position G; the auxiliary contact 80 electrically disconnected from the movable contact 10 (and from the second fixed contact 6); the motion transmission mechanism in the second configuration C2; and the movable arc contact 22 in an uncoupled position P4 from the fixed arc contact 21.

The first lever arm 311 of each first lever member 31 is not positioned along the motion trajectory of the movable contact 10 while the second lever arm 312 of each first lever member 31 is positioned along the motion trajectory of the movable contact 10.

No currents can flow between the first and second pole terminals 11, 12 and the second pole terminal 12 is put at a ground voltage.

The switching apparatus 1 carries out an opening maneuver, when it switches from the closed state to the open state.

During an opening maneuver of the switching apparatus, the movable contact 10 moves, according to the first rotation direction R1, between the first end-of-run position P_{A} and the intermediate position P_{B}. The movable contact 10 thus moves away from the corresponding first fixed contact 5.

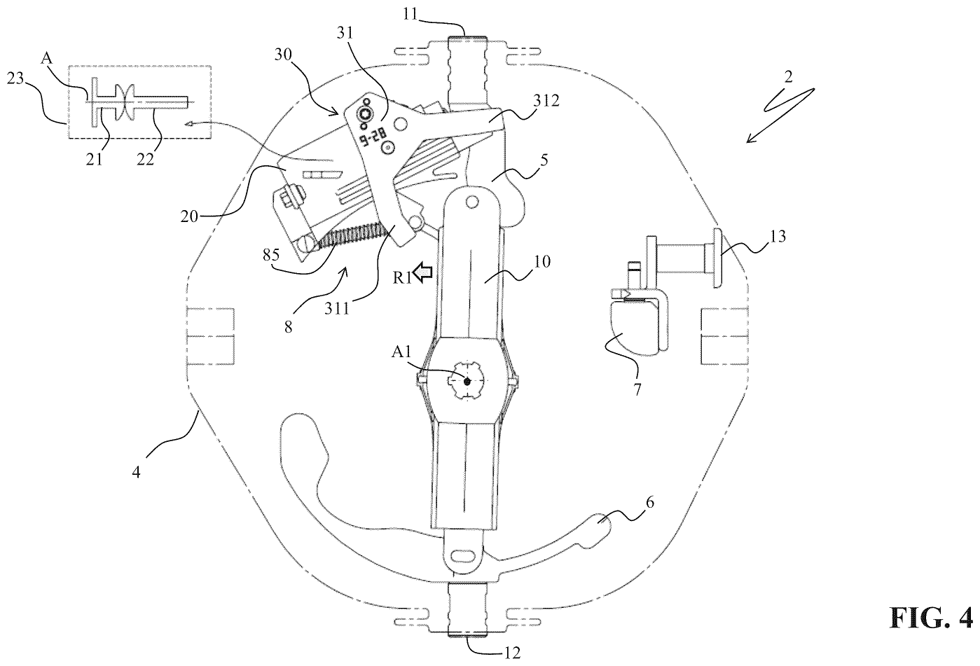

When the movable contact 10 starts moving according to the first rotation direction R1, the movable contact 10 is still in sliding contact to the first fixed contact 5 and it remains slidingly coupled to the second fixed contact 6 (FIG. 4).

At the same time, the movable contact 10 (namely the coupling member 10D thereof) couples with the contact lever 81 and actuates this latter.

The assembly formed by the support member 83, the auxiliary contact 80 and the contact lever 81 moves substantially as a rigid element about the third rotation axis A3 (according to an opposite rotation direction compared to the first rotation direction R1 of the movable contact.

The compression spring 85 starts being charged (more than the initial preloaded condition) and stores elastic energy (the support pin 82 slides relatively to the fixed support 25).

The contact lever 81 moves away from the rest position G and starts moving towards the first transient position G1 (FIGS. 4 and 12).

The movable contact 10 is thus electrically connected with the auxiliary contact 80 and it electrically connects both the first fixed contact 5 and the auxiliary contact 80 with the second fixed contact 6. A current can flow between the first and second pole terminals 11, 12 passing through the first fixed contact 5 and the vacuum interrupter 20 in parallel. Obviously, most of the current will flow along the first fixed contact 5 as the current path passing through this electric contact has a lower equivalent resistance with respect to the current path passing through the vacuum interrupter.

At this stage of the opening maneuver, the movable contact 10 does not interact with the motion transmission mechanism 30 yet.

Upon a further movement according to the first rotation direction R1, the movable contact 10 decouples from the first fixed contact 5 while remaining coupled to the contact lever 81.

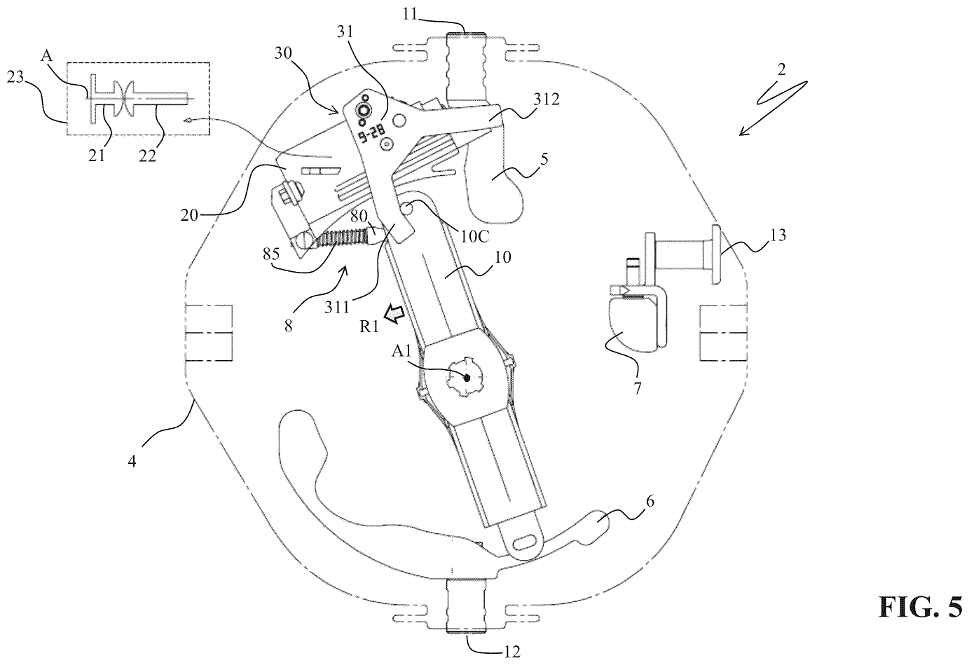

The assembly formed by the support member 83, the auxiliary contact 80 and the contact lever 81 continues to rotate about the third rotation axis A3. The contact lever 81 continues to move towards the first transient position G1 (FIGS. 5 and 13).

The movable contact 10 electrically disconnects the first fixed contact 5 from the second fixed contact 6 while maintaining the auxiliary contact 80 electrically connected with the second fixed contact 6. In this situation, a current flowing along the electric pole is fully deviated through the vacuum interrupter 20 as no current can flow through the first fixed contact 5. The formation of electric arcs at the contact regions of the movable contact 10 is thus prevented.

The compression spring 85 continues to be charged and store elastic energy.

While it is coupled to the contact lever 81 and the second fixed contact 6, the movable contact 10 (namely the coupling members 10C thereof) couples to and actuates the first lever arm 311 of each first lever member 31 (FIGS. 5 and 13).

The actuation of each first lever arm 311 by the movable contact 10 causes a transition of the motion transmission mechanism from the first configuration C1 to the second configuration C2 and a consequent movement of the movable arc contact 22 from the coupled position P3 with the fixed arc contact 21 to the uncoupled position P4 from the fixed arc contact 21.

The separation of the electric contacts 21, 22 causes the rising of electric arcs between said electric contacts. However, since the electric contacts 21, 22 are immersed in a vacuum atmosphere, such electric arcs can be quenched efficiently, thereby quickly leading to the interruption of the current flowing along the electric pole.

In the meanwhile, the movable contact 10 remains coupled to the contact lever 81 and maintains the auxiliary contact 80 electrically connected to the second fixed contact 6, thereby preventing the formation of electric arcs at the opposite contact regions of the movable contact 10.

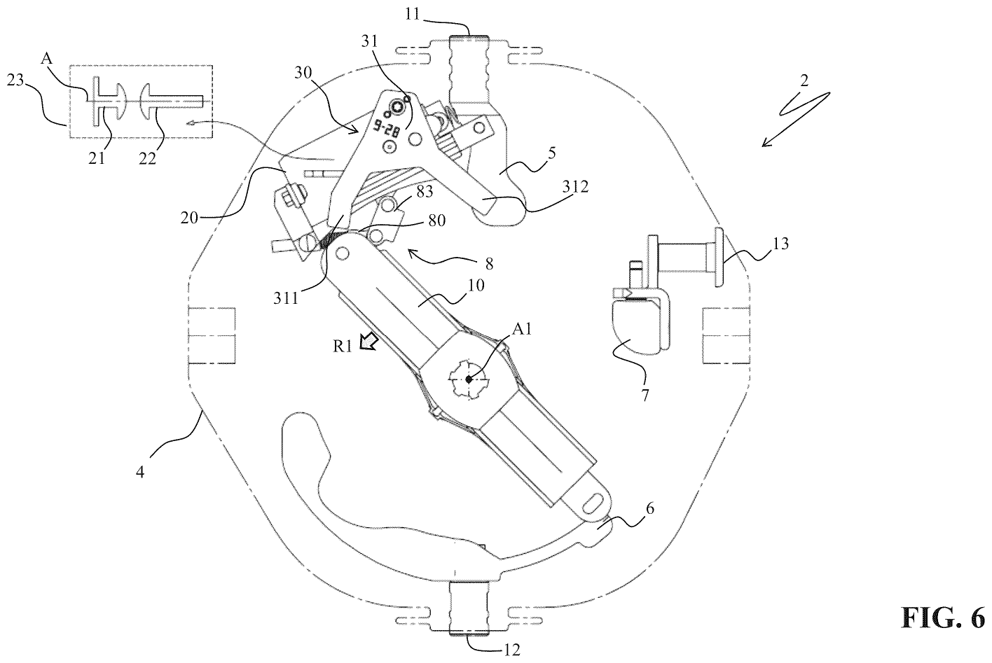

Upon a further movement towards the intermediate position P_{B}, according to the first rotation direction R1, the movable contact 10 decouples from the motion transmission mechanism 30, which remains in the second configuration C2 (FIGS. 6 and 14).

The movable contact 10 remains coupled to the contact lever 81 and maintains the auxiliary contact 80 electrically connected to the second fixed contact 6.

The assembly formed by the support member 83, the auxiliary contact 80 and the contact lever 81 continues to rotate about the third rotation axis A3. The contact lever 81 reaches the first transient position G1 and the compression spring 85 reaches its maximum compression.

Upon a further movement towards the intermediate position P_{B}, according to the first rotation direction R1, the movable contact 10 decouples from the contact lever 81. The auxiliary contact 80 and the second fixed contact 6 thus result electrically disconnected.

The compression spring 85 is free to release the stored elastic energy and returns to an initial preloaded condition (the support pin 82 slides relatively to the fixed support 25).

Upon actuation by the compression spring 86, the assembly formed by the support member 83, the auxiliary contact 80 and the contact lever 81 rotates according to an opposite direction about the third rotation axis A3. The contact lever 81 moves back to the rest position G.

The movable contact 10 then reaches the intermediate position P_{B}, which corresponds to an open state of the switching apparatus (FIG. 7).

The switching apparatus 1 carries out a closing maneuver, when it switches from the open state to the close state.

Before carrying out a closing maneuver, the switching apparatus may have carried out an opening-from-ground maneuver to switch in an open state.

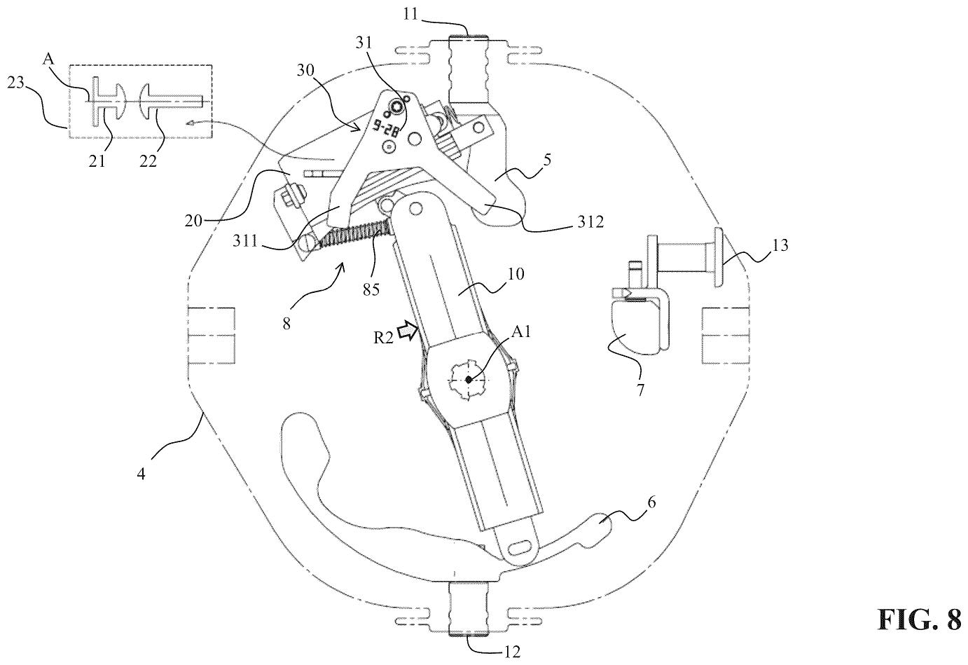

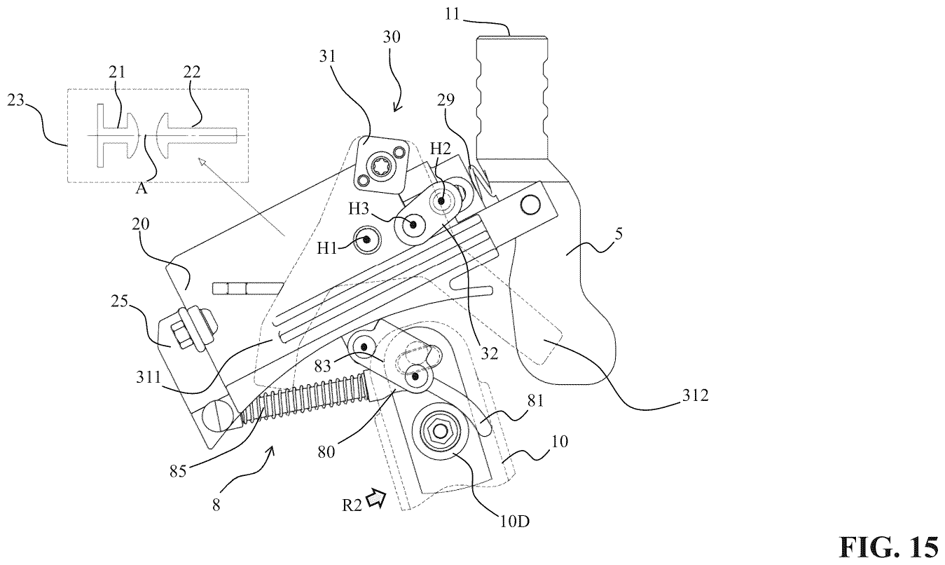

During a closing maneuver of the switching apparatus, the movable contact 10 moves, according to the second rotation direction R2, between the intermediate position P_{B} and the first end-of-run position P_{A}. The movable contact 10 thus moves towards the corresponding first fixed contact 5 (FIGS. 8 and 15).

Upon an initial movement according to the second rotation direction R2, the movable contact 10 couples to the contact lever 81 and causes the rotation of this latter about its rotation axis A2 against the opposition of the bending spring 86, which starts storing elastic energy.

The contact lever 81 moves away from the rest position G and starts moving towards the second transient position G2 (FIG. 15).

The movable contact 10 electrically connects the auxiliary contact 80 to the second fixed contact 6.

At this stage of the closing maneuver, the movable contact 10 does not interact with the motion transmission mechanism 30 yet.

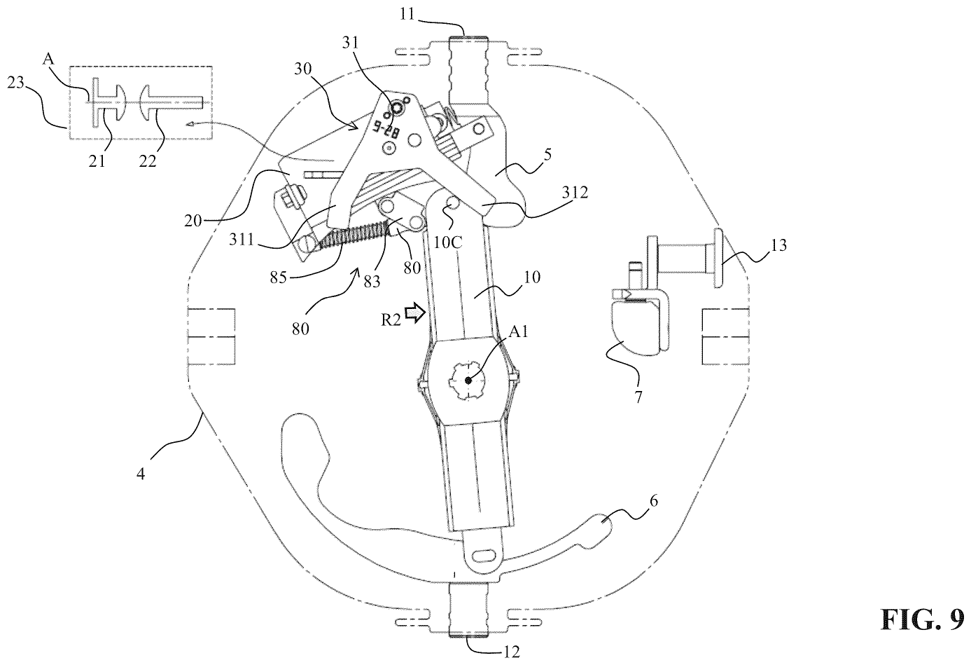

Upon a further movement according to the second rotation direction R2, the movable contact 10 couples to the first fixed contact 5 while remaining coupled to the contact lever 81 (FIGS. 9 and 16).

The contact lever 81 continues to move towards the second transient position G2 and the bending spring 86 continues to store elastic energy.

In this transitory situation, both the first fixed contact 5 and the fourth fixed contact 8 are electrically connected with the second fixed contact 6.

Upon a further movement according to the second rotation direction R2, the movable contact 10 decouples from the coupling lever 81.

The bending spring 86 is free to release the stored elastic energy. Upon actuation by the bending spring 86, the contact lever 81 moves back to the rest position G.

The movable contact 10 remains slidingly coupled to the first fixed contact 5 and to the second fixed contact 6 (FIGS. 9 and 16).

The movable contact 10 thus electrically disconnects the fourth fixed contact 8 from the second fixed contact 6 and it maintains the first fixed contact 5 and the second fixed contact 6 electrically connected. In this way, the vacuum interrupter 20 does not have to carry a possible short circuit current or an overload current or, more simply, a nominal current during the “making current” process.

While it is slidingly coupled to the first fixed contact 5 and to the second fixed contact 6, the movable contact 10 couples to and actuates the second lever arm 312 of each first lever member 31 (FIGS. 9 and 16).

The actuation of the second lever arm 312 of each first lever member 31 by the movable contact 10 causes a transition of the motion transmission mechanism 30 from the second configuration C2 to the first configuration C1 and a consequent movement of the movable arc contact 22 from the uncoupled position P4 from the fixed arc contact 21 to the coupled position P3 with the fixed arc contact 21. In the meanwhile, the movable contact 10 maintains the first fixed contact 5 electrically connected to the second fixed contact 6.

The movable contact 10 then reaches the first end-of-run position P_{A}, which corresponds to a closed state of the switching apparatus (FIG. 3).

The switching apparatus 1 carries out a closing-to-ground maneuver, when it switches from an open state to a grounded state.

Obviously, before carrying out a closing-to-ground maneuver, the switching apparatus must carry out an opening maneuver as described above to switch in an open state.

During a closing-to-ground maneuver of the switching apparatus, the movable contact 10 moves, according to the first rotation direction R1, between the intermediate position P_{B} and the second end-of-run position P_{C}.

When the movable contact 10 reaches the second end-of-run position P_{C}, its first movable contact 10 couples to the second fixed contact 6 and to the third fixed contact 7.

In this situation, the movable contact 10 electrically connects the second fixed contact 6 with the third fixed contact 7 and, consequently, the second pole terminal 12 with the ground terminal 13. The second pole terminal 12 results therefore put at a ground voltage.

The movable contact 10 does not interact with the contact arrangement 8 and the motion transmission mechanism 30. This latter remains in the second configuration C2, when the switching apparatus carries out a closing-to-ground maneuver.

The switching apparatus 1 carries out an opening-from-ground maneuver, when it switches from a grounded state to an open state.

During an opening-from-ground maneuver of the switching apparatus, the movable contact 10 moves, according to the second rotation direction R2, between the second end-of-run position P_{C} and the intermediate position P_{B}.

In this way, the movable contact 10 decouples from the second fixed contact 6 and from the third fixed contact 7. The movable contact 10 thus electrically disconnects the third fixed contact 7 from the second fixed contact 6. As a consequence, the movable contact 10 does not electrically connect the second pole terminal 12 with the ground terminal 13 anymore. The second pole terminal 12 is therefore at a floating voltage.

The movable contact 10 does not interact with the contact arrangement 8 and the motion transmission mechanism 30. This latter remains in the second configuration C2, when the switching apparatus carries out an opening-from-ground maneuver.

The operation of the switching apparatus occurs according to similar operating modes if the switching apparatus is of the “single disconnection” type.

The switching apparatus, according to the present disclosure, provides remarkable advantages with respect to the known apparatuses of the state of the art.

The switching apparatus of the present disclosure includes, for each electric pole, an auxiliary contact arrangement including a movable contact lever 81.

Compared to the available solutions of the state of the art, this solution ensures an optimal transient electrical connection between the auxiliary contact 8 and the movable contact 10 during an opening and a closing maneuver of the switching apparatus. The formation of a current path through the vacuum interrupter during an opening maneuver and a closing maneuver of the switching apparatus is therefore made easier and safer.

The breaking process of the current flowing along each electric pole can be easily made to occur at level of the arc contacts 21, 22 accommodated in the vacuum chamber 23. Possible electric arcs, which derive from the interruption of a current flowing along each electric pole, therefore form in a vacuum atmosphere only, which allows improving their quenching process.

On the other hand, during a closing maneuver, the vacuum interrupter 20 has not to carry a possible short circuit current or an overload current or, more simply, a nominal current. This allows designing a more compact vacuum chamber 23, which allows obtaining a size and cost reduction for the overall switching apparatus.

The switching apparatus of the present disclosure includes, for each electric pole, a bistable motion transmission mechanism 30, which allows the movable contact 10 to drive the separation of the movable arc contact 22 from the fixed arc contact 21 depending on the position reached during an opening maneuver of the switching apparatus.

As illustrated above, the lever arms 311, 312 of each first lever member 31 of the motion transmission mechanism 30 are actuatable at different points of the motion trajectory of the movable contact 10. This solution improves the synchronization between the movement of the movable arc contact 22 and the movement of the movable contact 10.

The switching apparatus of the present disclosure has electric poles with a very compact, simple, and robust structure with relevant benefits in terms of size optimization.

The switching apparatus, according to the present disclosure, ensures high-level performances in terms of dielectric insulation and arc-quenching capabilities during the current breaking process and, at the same time, it is characterized by high levels of reliability for the intended applications.

The switching apparatus, according to the present disclosure, is of relatively easy and cheap industrial production and installation on the field.

The disclosed systems and methods are not limited to the specific embodiments described herein. Rather, components of the systems or activities of the methods may be utilized independently and separately from other described components or activities.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A switching apparatus for medium voltage electric systems, said switching apparatus comprising one or more electric poles, wherein, for each electric pole, said switching apparatus comprises:
a first pole terminal;
a second pole terminal;
a ground terminal, wherein:
said first pole terminal is electrically couplable to a first conductor of an electric line,
said second pole terminal is electrically couplable to a second conductor of said electric line, and
said ground terminal is electrically couplable to a grounding conductor;
a plurality of fixed contacts spaced apart one from another, said plurality of fixed contacts comprising:
a first fixed contact electrically connected to said first pole terminal;
a second fixed contact electrically connected to said second pole terminal; and
a third fixed contact electrically connected to said ground terminal;
a movable contact reversibly movable about a corresponding first rotation axis according to opposite first and second rotation directions, so that said movable contact can be coupled to or uncoupled from said fixed contacts;
a vacuum interrupter comprising:
a fixed arc contact and a movable arc contact electrically connected to said first pole terminal and reversibly movable along a corresponding translation axis between a coupled position with said fixed arc contact and an uncoupled position from said fixed arc contact; and
a vacuum chamber, in which said fixed arc contact and said movable arc contact are enclosed and can be coupled or decoupled;
a motion transmission mechanism operatively coupled to said movable arc contact, said motion transmission mechanism actuatable by said movable contact to cause a movement of said movable arc contact along said translation axis, when said movable contact moves about said rotation axis during an opening maneuver and a closing maneuver of said switching apparatus; and
an auxiliary contact arrangement including an auxiliary contact electrically connected to said fixed arc contact and a contact lever electrically connected to said auxiliary contact and reversibly movable about a corresponding second rotation axis,
wherein said contact lever is couplable to said movable contact to connect electrically said movable contact to said auxiliary contact in a transient manner, during the opening maneuver and the closing maneuver of said switching apparatus.

2. The switching apparatus, according to claim 1, wherein:
said movable contact couples to said contact lever before decoupling from said first fixed contact, during the opening maneuver of said switching apparatus, and
said movable contact couples to said first fixed contact before decoupling from said contact lever, during the closing maneuver of said switching apparatus.

3. The switching apparatus, according to claim 1, wherein said contact lever moves from a rest position to a first transient position, upon actuation by said movable contact, when said movable contact couples to said contact lever, during the opening maneuver of said switching apparatus.

4. The switching apparatus, according to claim 3, wherein said contact lever moves back from said first transient position to said rest position, upon actuation by a first elastic member of said auxiliary contact arrangement, when said movable contact decouples from said contact lever, during the opening maneuver of said switching apparatus.

5. The switching apparatus, according to claim 1, wherein said contact lever moves from a rest position to a second transient position, upon actuation by said movable contact, when said movable contact couples to said contact lever, during the closing maneuver of said switching apparatus.

6. The switching apparatus, according to claim 5, wherein said contact lever moves back from said second transient position to said rest position, upon actuation by a second elastic member of said auxiliary contact arrangement, when said movable contact decouples from said contact lever, during the closing maneuver of said switching apparatus.

7. The switching apparatus, according to claim 1, wherein said auxiliary contact arrangement comprises a support member pivoted on a fixed support and supporting said auxiliary contact and said contact lever, and
wherein said contact lever is pivoted on said support member.

8. The switching apparatus, according to claim 7, wherein said auxiliary contact arrangement comprises:
a first elastic member arranged between a fixed support and said support member or said auxiliary contact; and
a second elastic member arranged between said support member or said auxiliary contact and said contact lever.

9. The switching apparatus, according to claim 1, wherein said motion transmission mechanism comprises a first lever member pivoted on a fixed support at a first hinge axis and a second lever member pivoted on said movable arc contact at a second hinge axis,
wherein each first lever member and each corresponding second lever member are pivoted relative each other at a third hinge axis, wherein each first lever member comprises first and second lever arms alternatively actuatable by said movable contact at different points of the motion trajectory of said movable contact during the opening maneuver and the closing maneuver of said switching apparatus.

10. The switching apparatus, according to claim 9, wherein the first lever arm of each first lever member is actuated by said movable contact during the opening maneuver of said switching apparatus, and wherein the second lever arm of each first lever member is actuated by said movable contact during the closing maneuver of said switching apparatus.

11. The switching apparatus, according to claim 1, wherein:
said motion transmission mechanism is configured to take a first configuration, at which said movable arc contact is in said coupled position, and a second configuration, at which said movable arc contact is in said uncoupled position,
said motion transmission mechanism is configured to stably maintain said first configuration or said second configuration, if the lever arms of each first lever member are not actuated by said movable contact, and
said motion transmission mechanism is configured to change configuration, if a lever arm of each first lever member is actuated by said movable contact.

12. The switching apparatus, according to claim 11, wherein said motion transmission mechanism is configured to switch from said first configuration to said second configuration upon an actuation of the first lever arm of each first lever member by said movable contact, and wherein a transition of said motion transmission mechanism from said first configuration to said second configuration causes a movement of said movable arc contact from said coupled position to said uncoupled position.

13. The switching apparatus, according to claim 11, wherein said motion transmission mechanism is configured to switch from said second configuration to said first configuration upon an actuation of the second lever arm of each first lever member by said movable contact, and wherein a transition of said motion transmission mechanism from said second configuration to said first configuration causes a movement of said movable arc contact from said uncoupled position to said coupled position.

14. The switching apparatus, according to claim 1, it wherein the switching apparatus is a load-break switch for medium voltage electric systems.

15. The switching apparatus, according to claim 2, wherein said contact lever moves from a rest position to a first transient position, upon actuation by said movable contact, when said movable contact couples to said contact lever, during the opening maneuver of said switching apparatus.

16. The switching apparatus, according to claim 2, wherein said contact lever moves from a rest position to a second transient position, upon actuation by said movable contact, when said movable contact couples to said contact lever, during the closing maneuver of said switching apparatus.

17. The switching apparatus, according to claim 3, wherein said contact lever moves from the rest position to a second transient position, upon actuation by said movable contact, when said movable contact couples to said contact lever, during the closing maneuver of said switching apparatus.

18. The switching apparatus, according to claim 2, wherein said auxiliary contact arrangement comprises a support member pivoted on a fixed support and supporting said auxiliary contact and said contact lever, and wherein said contact lever is pivoted on said support member.

19. The switching apparatus, according to claim 3, wherein said auxiliary contact arrangement comprises a support member pivoted on a fixed support and supporting said auxiliary contact and said contact lever, and wherein said contact lever is pivoted on said support member.

20. The switching apparatus, according to claim 5, wherein said auxiliary contact arrangement comprises a support member pivoted on a fixed support and supporting said auxiliary contact and said contact lever, and wherein said contact lever is pivoted on said support member.
